(19) United States
(12) Patent Application Publication
(10) Pub. No.: US 2022/0254329 A1
(43) Pub. Date: Aug. 11, 2022

(54) SPEAKER UNIT AND SOUND SYSTEM

(71) Applicant: SONY GROUP CORPORATION, TOKYO (JP)

(72) Inventors: SHIGETOSHI HAYASHI, TOKYO (JP); TETSUNORI ITABASHI, TOKYO (JP); KOHEI ASADA, TOKYO (JP); KENICHI MAKINO, TOKYO (JP)

(21) Appl. No.: 17/310,329

(22) PCT Filed: Jan. 29, 2020
(86) PCT No.: PCT/JP2020/003060

§ 371 Date: Jul. 28, 2021

(30) Foreign Application Priority Data
Feb. 5, 2019 (JP) 2019-018402

(51) Int. Cl. G10K 11/178; H04R 1/04; H04R 1/32; H04R 1/40; H04R 3/12; H04R 1/02

(52) U.S. Cl. CPC G10K 11/17881; H04R 1/04; H04R 1/326; H04R 1/403; H04R 3/12; G10K 2210/3011; G10K 11/17825; H04R 1/025; G10K 2210/3044; G10K 2210/3027; G10K 2210/3026; G10K 11/17823

(57) ABSTRACT

Provided is a speaker unit that constitutes a sound system that reduces noise in an open space, including: a housing; a driver; and a microphone, in which the microphone and the driver are provided in the housing such that sensitivity of the microphone to a signal output from the driver is lower.

### TECHNICAL FIELD

The present technology relates to a speaker unit and a sound system.

### BACKGROUND ART

Conventionally, there has been proposed a noise canceling method of reducing noise in a closed space by the use of a predetermined number of speakers and microphones (Patent Literature 1).

With the technology described in Patent Literature 1, in a filter circuit in feedforward noise canceling, a reference microphone is arranged in a null area generated by giving directivity to a speaker for canceling, and noise of a frequency band increased due to feedback noise canceling is reduced.

### CITATION LIST

### Patent Literature

Patent Literature 1: Japanese Patent Application Laid-open No. 2009-273069

### DISCLOSURE OF INVENTION

### Technical Problem

However, there is a problem that the range in which the sound output from the speaker can be heard is limited in a case where the directivity is given to the speaker. Moreover, since no shield exists between a speaker (driver) and a microphone in a space sound system as in noise canceling of headphones, return components from the speaker to the microphone are not negligible. Thus, there is also a problem that the return components form a closed loop between the speaker and the microphone and the risk of howling increases.

The present technology has been made in view of such problems and it is an object thereof to provide a speaker unit and a sound system that are capable of suppressing formation of a closed loop due to the input of a cancel signal into a microphone for noise collection.

### Solution to Problem

In order to solve the above-mentioned problems, a first technology is a speaker unit that constitutes a sound system that reduces noise in an open space, including: a housing; a driver; and a microphone, in which the microphone and the driver are provided in the housing such that sensitivity of the microphone to a signal output from the driver is lower.

Moreover, a second technology is a sound system that includes a plurality of speaker units and reduces noise in an open space, the speaker units each including a housing, a speaker, and a microphone, in which the microphone and the driver are provided in the housing such that sensitivity of the microphone to a signal output from the driver is lower.

### BRIEF DESCRIPTION OF DRAWINGS

FIG. 1 A block diagram showing the outline of signal processing in a feedforward system.

FIG. 2A is a schematic diagram of a configuration of a typical noise canceling headphone and FIG. 2B is a diagram showing a configuration of a conventional speaker unit to be used for noise reduction in a space.

FIG. 3 An explanatory diagram of a closed loop.

FIG. 4 A diagram showing a configuration of a sound system 10.

FIG. 5 A diagram showing an arrangement example of microphones and speakers in the sound system 10.

FIG. 6A is a side view showing a configuration of a speaker unit 200, FIG. 6B is a front view showing the configuration of the speaker unit 200, and FIG. 6C is a front view showing another configuration example of the speaker unit 200.

FIG. 7 is an explanatory diagram of a bi-directional microphone.

FIG. 8 is a configuration diagram of a speaker unit 200 including the bi-directional microphone.

FIG. 9A is an explanatory diagram of a uni-directional microphone.

FIG. 10 is a configuration diagram of the speaker unit 200 including the uni-directional microphone.

FIG. 11 A diagram showing another example of the uni-directional microphone.

FIG. 12 A graph of a transfer function based on actual measurement showing the effects of the present technology.

FIG. 13 A diagram for describing the effects of the present technology by theoretical analysis.

FIG. 14 A diagram for describing the effects of the present technology by theoretical analysis.

FIG. 15 A graph showing a sound collection amplitude ratio of the microphone.

FIG. 16 A signal processing block diagram showing the effects of the present technology in feedforward noise canceling.

FIG. 17 A signal processing block diagram showing the effects of the present technology in noise canceling using a feedforward system and a feedback system at the same time.

FIG. 18 A signal processing block diagram showing the effects of the present technology in noise canceling using a feedforward system and a feedback system at the same time.

FIG. 19 A signal processing block diagram showing the effects of the present technology in noise canceling using a feedforward system and a feedback system at the same time.

FIG. 20 A diagram showing a first modified example of the sound system 10.

FIG. 21 A diagram showing a second modified example of the sound system 10.

### MODE(S) FOR CARRYING OUT THE INVENTION

An embodiment of the present technology will be described below with reference to the drawings. It should be noted that descriptions will be given in the following order.
<1. Embodiment>
[1-1. Typical Noise Canceling Systems]
[1-2. Configuration of Sound System 10 and Signal processing apparatus 100]
[1-3. Configuration of Speaker Unit 200]
[1-4. First Example of Microphone]
[1-5. Second Example of Microphone]
[1-6. Confirmation of Effects of Present Technology]
<2. Modified Examples>

### 1. Embodiment

[1-1. Typical Noise Canceling Systems]

First of all, noise canceling systems for reducing noise will be described. The noise canceling systems may be roughly classified into a feedforward system and a feedback system.

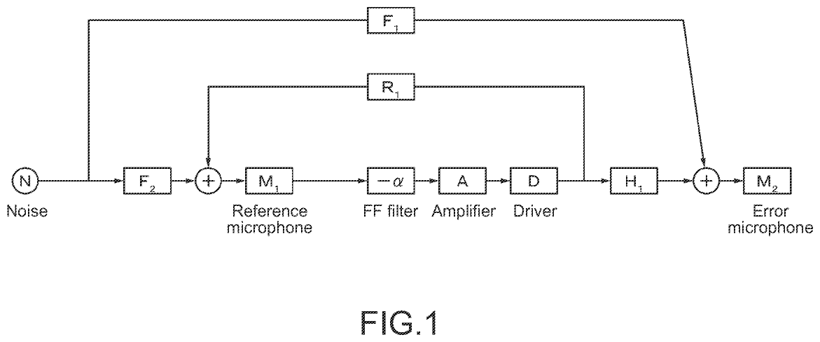

FIG. 1 is a block diagram showing the outline of signal processing in the feedforward system. M1 denotes a reference microphone. M2 denotes an error microphone. F1 denotes a transfer function from a noise source to the error microphone. F2 denotes a transfer function from the noise source to the reference microphone. α denotes a feedforward noise canceling filter. A denotes an amplifier. D denotes a driver. H1 denotes a transfer function from the driver to the error microphone. R1 denotes a transfer function from the driver to the reference microphone.

In the feedforward system, noise is collected by the microphone to obtain a noise signal, the noise signal is subjected to predetermined signal processing to generate a cancel signal, and the cancel signal is output from the driver for reducing noise. In the feedforward system, the reference microphone that collects noise is required.

In the feedback system, a sound reproduced within a processing target area of noise reduction and noise are collected by the microphone. This audio signal is subjected to predetermined signal processing to generate a cancel signal. Then, the cancel signal is output from the driver, such that the noise is reduced.

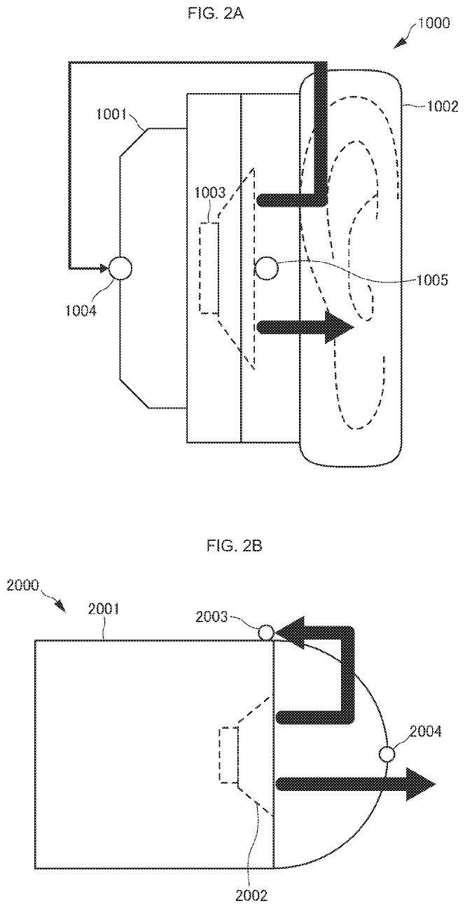

FIG. 2A is a schematic diagram of a configuration of a typical noise canceling headphone 1000 and FIG. 2B is a diagram showing a configuration of a speaker unit 2000 used for noise reduction of an open space in a conventional system.

The noise canceling headphone 1000 includes a housing 1001, an ear pad 1002, a driver 1003 provided in the housing 1001, a reference microphone 1004, and an error microphone 1005. A reference microphone 1004 is mounted on the exterior of the housing 1001.

The speaker unit 2000 includes a housing 2001, a driver 2002, a reference microphone 2003, and an error microphone 2004. The reference microphone 2003 is provided on the outer surface of the housing 2001 in an exposed state. The reference microphone 2003 is positioned near the driver 2002 in this manner because the closer the position of the reference microphone 2003 and the position of the driver 2002, the higher the correlation between the reference signal and the ideal output signal, facilitating the generation of an antiphase signal for noise reduction.

As shown in FIG. 2A and FIG. 2B, both the noise canceling headphone 1000 and the speaker unit 2000 include a reference microphone and an error microphone, which are quite similar in configuration.

Now consider the feedback path from the driver 1003 to the reference microphone 1004 in the noise canceling headphone 1000. While the user wears the noise canceling headphone 1000, the head and ears are shields and the cancel signal output from the driver 1003 to arrive at the reference microphone 1004 is sufficiently negligible. A component of the cancel signal, which returns to the reference microphone 1004, will be referred to as return components. Moreover, since the sound reproduced from the driver 1003 is output to the open space when the noise canceling headphone 1000 is not mounted, the return components are also sufficiently negligible in this case. That is, it can be considered that in the noise canceling headphone 1000, the cancel signal that reaches the eardrum and the cancel signal that arrives at the reference microphone 1004 are separated from each other at a high level. In other words, it can be said that in the block diagram shown in FIG. 1, a transfer function R1 from the driver 1003 to the reference microphone 1004 is sufficiently small and negligible.

Since there is no shield between the driver 2002 and the reference microphone 2003 as shown in FIG. 2B, the cancel signal from the driver 2002 is output within the processing area of noise reduction and is returned and input into the reference microphone 2003. The return components of the cancel signal, which return to the reference microphone 2003, correspond to the transfer function R1 in FIG. 1.

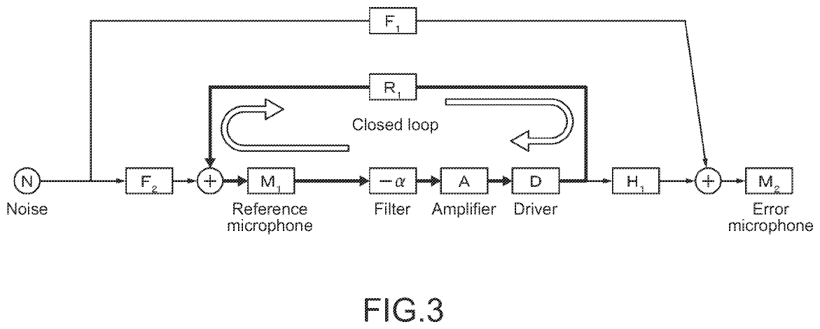

When the influence of the transfer function R1 increases to an extent that it is not negligible, an undesired closed loop is formed by a reference microphone M1 and a driver D as shown in FIG. 3. As a result, occurrence of howling, reduction of the noise reduction effect, and the like occur.

[1-2. Configurations of Sound System 10 and Signal Processing Apparatus 100]

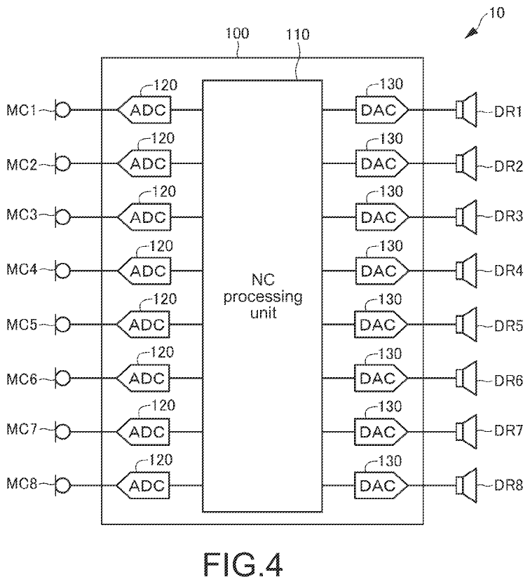

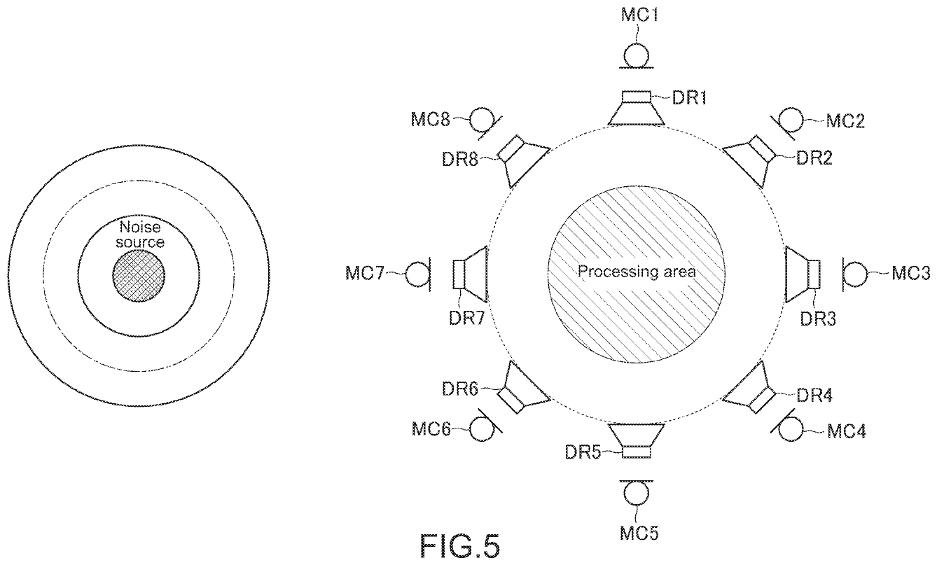

The configuration of the sound system 10 according to the present technology will be described with reference to FIGS. 4 and 5. The sound system 10 performs noise reduction processing in the open space (hereinafter, referred to as processing area) that is a target of the noise reduction processing. The sound system 10 includes a signal processing apparatus 100, microphones MC, and drivers DR. The microphones MC and the drivers DR constitute a speaker unit 200. A configuration of the speaker unit 200 will be described later.

The signal processing apparatus 100 includes a noise canceling processing unit 110, analog/digital (AD) converters 120, and digital/analog (DA) converters 130.

The plurality of microphones MC (MC1 to MC8) is connected to the noise canceling processing unit 110 via the plurality of AD converters 120. Moreover, the plurality of drivers DR (DR1 to DR2) is connected to the noise canceling processing unit 110 via the plurality of DA converters 130. The number of microphone MC and the number of drivers DR are not limited to the numbers shown in the figure, and it is also possible to connect dozens or hundreds of microphones and drivers to the signal processing apparatus 100.

In this embodiment, as shown in FIG. 5, the plurality of microphones MC1 to MC8 and the plurality of drivers DR1 to DR8 are arranged in a ring-shaped array so as to surround the processing area. Each of the microphones MC and each of the drivers DR as a pair constitute a channel and the same number of microphones MC as the drivers DR are provided. It is assumed that the noise source is outside the processing area.

Thus, a plurality of inputs and a plurality of outputs are connected to the signal processing apparatus 100. Thus, the signal processing apparatus 100 is configured as a multi input-multi output apparatus. A plurality of inputs and a plurality of outputs enable noise emitted from the noise source to be reduced in the processing area that is a target of the noise canceling processing.

The microphones MC collect noise from the noise source. Audio signals based on sound collection results of the microphones MC are supplied to the AD converters 120.

The AD converters 120 convert the audio signals that are analog signals into digital signals and supplies the digital audio signals to the noise canceling processing unit 110. The signal processing apparatus 100 includes the same number of AD converters 120 as the microphones MC.

The noise canceling processing unit 110 includes a digital filter for generating a cancel signal for noise reduction. The noise canceling processing unit 110 uses the supplied digital audio signals to generate cancel signals of characteristics according to filter coefficients as predetermined parameters and supplies the cancel signals to the DA converters 130. The noise canceling processing unit 110 generates a cancel signal for feedforward in feedforward noise canceling and generates a cancel signal for feedback in feedback noise canceling. The noise canceling processing unit 110 is a digital signal processing circuit constituted by a digital signal processor (DSP), for example.

The DA converters 130 convert the supplied cancel signals into analog signals and supply the analog cancel signals to the drivers DR. The cancel signals are output from the drivers DR constituting the speaker unit 200. This makes it possible to reduce the noise in the processing area. The signal processing apparatus 100 includes the same number of DA converters 130 as the drivers DR.

It should be noted that the signal processing apparatus 100 is configured by a program and the program may be installed in advance in a processor such as a DSP or a computer that performs signal processing or may be distributed by downloading, a storage medium, or the like and installed by the user him or herself. Alternatively, the signal processing apparatus 100 may be implemented not only by the program, but also by a combination of dedicated devices, circuits, and the like by hardware having its functions. The signal processing apparatus 100 may be provided inside the speaker unit 200 or may be configured by being installed in a personal computer or the like separate from the speaker unit 200.

In this manner, the sound system 10 is configured. It should be noted that the number of microphones MC and the number of drivers DR in FIGS. 4 and 5 are merely an example, and the present technology is not limited to those numbers. The number of microphones MC and the number of drivers DR may be increased or decreased in accordance with the size of the processing area that is the noise reduction target.

[1-3. Configuration of Speaker Unit 200]

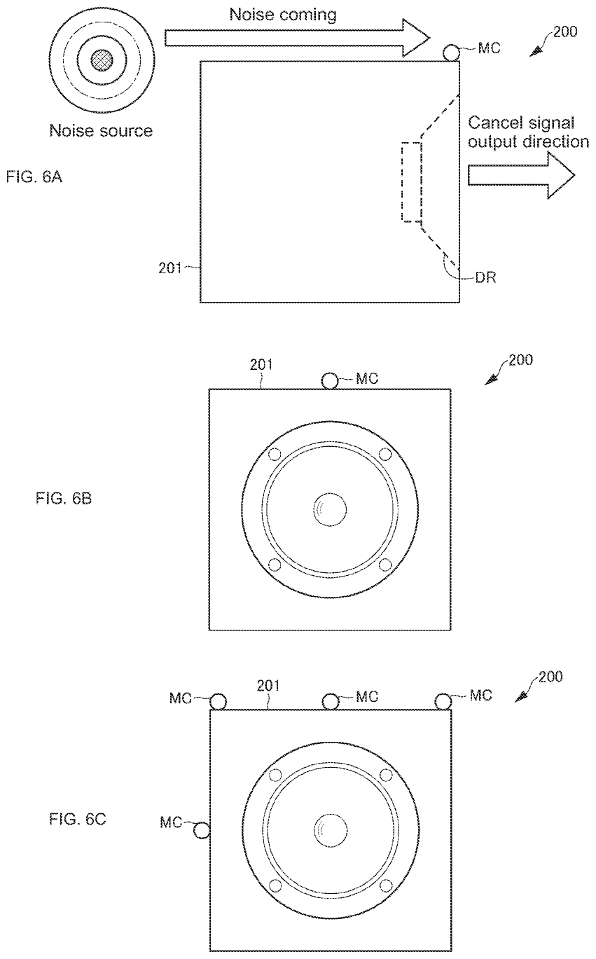

Next, the configuration of the speaker unit 200 according to the present technology will be described with reference to FIG. 6. FIG. 6A is a side view of the speaker unit 200 and FIG. 6B is a front view of the speaker unit 200. The speaker unit 200 includes a housing 201, microphones MC, drivers DR. The microphones MC and drivers DR are the microphones MC and drivers DR described in FIGS. 4 and 5.

The housing 201 includes therein the drivers DR and various other circuits, power lines, signal lines, and the like constituting the speaker unit and is constituted by a wooden or metal plate in a box shape. The housing 201 may have a cubic shape, a rectangular parallelepiped shape, a cylindrical shape, and the like. The drivers DR are provided inside the housing 201 and a vibration plate that outputs audio and cancel signals is configured to be exposed to the outside. The cancel signal output from the drivers DR behaves like a point sound source in the low range of long wavelength and has the property that it attenuates in accordance with the distance.

The microphones MC are for collecting noise from the noise source and supplying the noise to the signal processing apparatus 100. In a case where the noise source is located at a position in a direction opposite to the output direction from the driver DR as shown in FIG. 6A, the microphone MC is provided on the housing 201 at a position at which the noise is not shielded by the housing 201 and directly arrives at the microphone MC and which is a position closest to the driver DR. It should be noted that the microphone MC may be provided at any position of the housing 201 as shown in FIG. 6C as long as this condition is satisfied.

[1-4. First Example of Microphone]

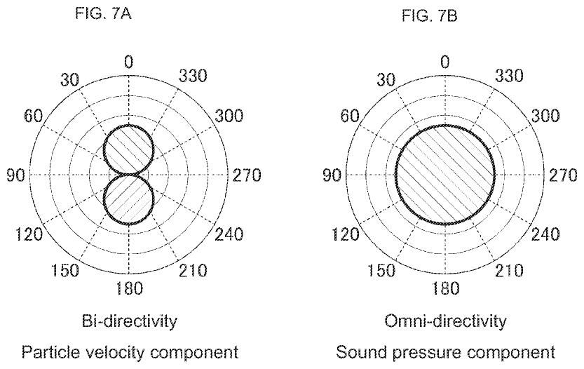

Here, a first configuration example of the microphone MC will be described. In the first example, the microphone MC is configured as a bi-directional microphone. As shown in FIG. 7A, the bi-directional microphone MC is a microphone having uni-directivity on each of the front and back sides of the microphone MC, i.e., directivity of two directions unlike an omni-directional microphone shown in FIG. 7B. A direction having the directivity is a direction in which the sensitivity of the microphone MC is greatest. In FIG. 7, a direction of directions of 360 degrees in which the hatched circle area surrounded by the solid line exists is the direction in which the microphone MC has the directivity. It should be noted that the omni-directional microphone MC has an output proportional to the sound pressure and the bi-directional microphone MC has an output proportional to the particle velocity.

The bi-directional microphone MC is capable of collecting audio and cancel signals from the direction having the directivity. Moreover, a direction having no directivity exists in the bi-directional microphone MC and the sensitivity to audio and cancel signals from such a direction is low. The direction having no directivity in the bi-directional microphone MC will be referred to as a null. Regarding the directions of the bi-directivity in the bi-directional microphone MC, in a case where one directivity direction is considered as a reference, it is an approximately 180-degree direction with respect to the one directivity direction. Therefore, an approximately 90-degree direction and an approximately 270-degree direction with respect to the one directivity direction that is the reference are nulls.

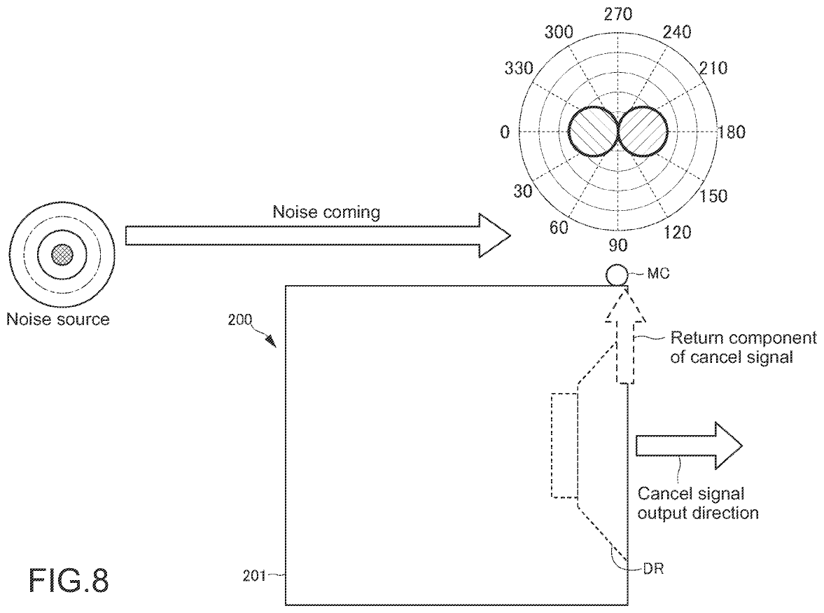

In the first example of the microphone MC, the microphone MC is arranged on the housing 201 in the speaker unit 200 such that the one directivity direction of the microphone MC corresponds to the direction of the noise source as shown in FIG. 8 and the direction of the driver DR corresponds to one null (approximately 90-degree direction) with low sensitivity. Accordingly, it is possible to allow the noise from the noise source to arrive at the microphone MC without being shielded by the housing 201 and to reduce the return components of the cancel signal output from the driver DR and collected by the microphone MC.

[1-5. Second Example of Microphone]

Next, a second configuration example of the microphone MC will be described. In the second example, the microphone MC is configured as a microphone having uni-directivity. The uni-directivity is also called cardioid and the uni-directional microphone is also called cardioid microphone.

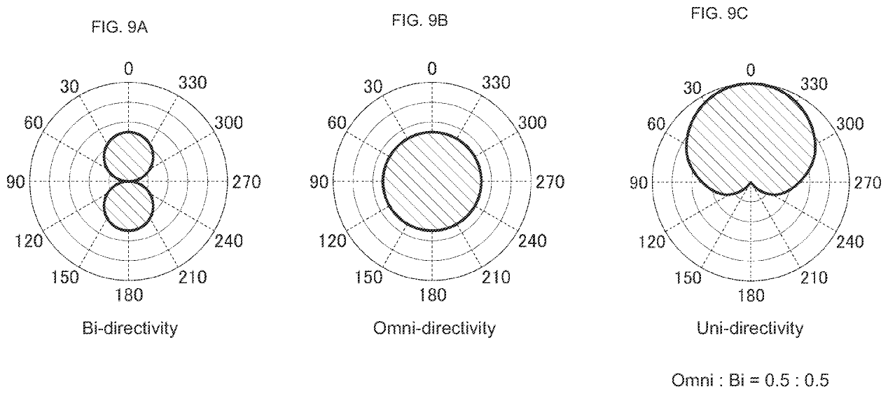

The uni-directional microphone MC is configured by mixing bi-directional components shown in FIG. 9A and omni-directional components shown in FIG. 9B at a ratio of “0.5:0.5”, and its directivity can be represented as a direction in which the hatched area surrounded by the solid line exists as shown in FIG. 9C. In a case where the direction of the uni-directivity indicated by the hatched area with the solid line in FIG. 9C is considered as a reference, an approximately 90-degree direction, an approximately 180-degree direction, and an approximately 270-degree direction with respect to the direction of the uni-directivity are nulls in which the sensitivity of the microphone MC is low.

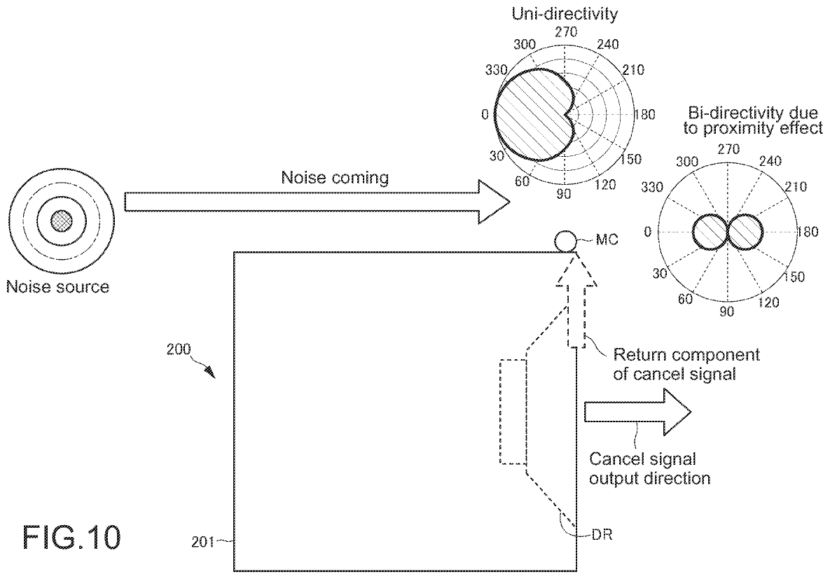

In the second example, the microphone MC is arranged on the outer surface of the housing 201 in the speaker unit 200 such that the directivity direction of the uni-directional microphone MC corresponds to the direction of the noise source and one low-sensitivity null corresponds to the direction of the driver DR as shown in FIG. 10. This makes it possible to collect the noise arriving at the microphone MC from the noise source without being shielded in the direction having the directivity with the highest sensitivity. Furthermore, it is possible to reduce the return components of the cancel signal output from the driver DR and collected by the microphone MC.

It should be noted that the microphone MC operates with a directivity similar to that of the bi-directional microphone due to the so-called proximity effect in a case where the distance between the driver and the uni-directional microphone MC is short. The directions of the bi-directivity are the direction of the uni-directivity and an approximately 180-degree direction with respect to the direction of the uni-directivity. Therefore, an approximately 90-degree direction and an approximately 270-degree direction with respect to the direction of the uni-directivity are nulls. The microphone MC is arranged on the outer surface of the housing 201 such that the null of the microphone MC correspond to the direction of the driver. Accordingly, it is possible to allow the noise from the noise source to arrive at the microphone MC without being shielded and to reduce the return components of the cancel signal output from the driver DR and collected by the microphone MC.

In a case where the driver DR and the microphone MC are close, the uni-directional microphone MC may be used as the reference microphone MC. In this case, the sound collection of the return components of the cancel signal can be reduced and the transfer function R1 can be reduced due to the null as in a case where the bi-directional microphone MC is used as the reference microphone MC.

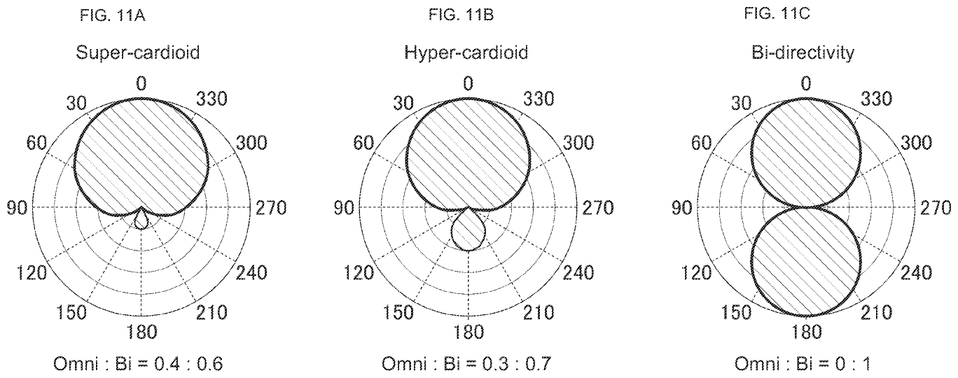

It should be noted that in a case where the microphone MC is configured as the uni-directional microphone, it is not limited to the example in which the omni-directional components and the bi-directional components are mixed at the ratio of “0.5:0.5” as described above. As shown in FIG. 11A, a so-called super-cardioid obtained by mixing the omni-directional components and the bi-directional components at a ratio of “0.4:0.6” may be used or a so-called hyper-cardioid obtained by mixing the omni-directional components and the bi-directional components at a ratio of “0.3:0.7” as shown in FIG. 11B may be used. Any microphone can be used as the microphone MC as long as it is a bi-directional microphone or a directional microphone in which the bi-directional components are used and synthesized, such as various types of uni-directional microphones.

[1-6. Confirmation of Effects of Present Technology]

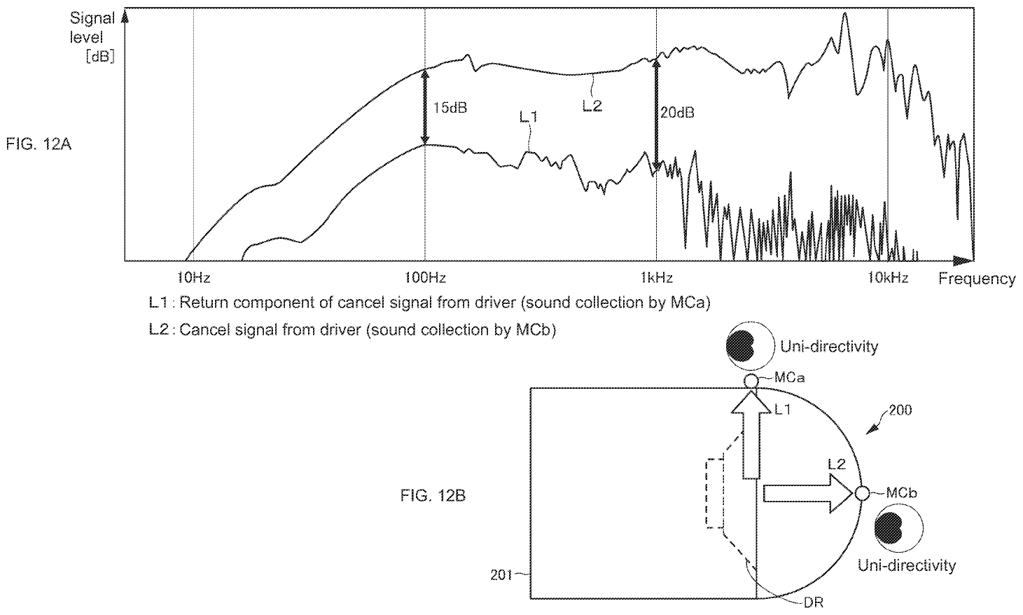

Next, the confirmation of the effects of the present technology described above will be described. FIG. 12A is a result of measuring the transfer function from the cancel signal collected by a uni-directional first microphone MCa and a uni-directional second microphone MCb which are arranged at positions approximately equidistant from the driver DR as shown in FIG. 12B. The first microphone MCa is arranged such that the directivity direction does not correspond to the direction of the driver DR while the null corresponds to the direction of the driver DR. It should be noted that the first microphone MCa is a microphone for collecting noise from the noise source as in the microphone shown in FIG. 10. The second microphone MCb is arranged such that the directivity direction corresponds to the direction of the driver DR. Note that it is assumed that the speaker unit 200 is a sealed speaker unit with the driver DR built in the housing 201.

The transfer function from the driver DR to the microphone MCa is equivalent to the transfer function R1 in FIG. 1 and the transfer function of the microphone MCb from the driver DR is equivalent to the transfer function H1 in FIG. 1.

In a case where the return transfer function R1 is sufficiently smaller than the transfer function H1, it may be considered that R1 that is the return components is negligible. That is, it can be said that the larger the difference between the transfer function from the driver DR to the first microphone MCa and the transfer function from the driver DR to the second microphone MCb, the better.

As it can be seen from FIG. 12, the difference between the cancel signal collected by the second microphone MCb whose directivity direction is directed toward the driver DR and the return components of the cancel signal collected by the first microphone MCa whose null is directed to the driver DR is about 15 dB at 100 Hz and about 20 Hz at 1 kHz. It should be noted that such a difference is favorably at least 10 dB or more.

It can be seen that the cancel signal from the driver DR is reduced in the first microphone MCa whose null is directed to the driver DR as compared to the second microphone MCb whose directivity direction is directed to the driver DR. Thus, it can be realized that a situation where the return components of the cancel signal are collected by the first microphone MCa provided at the position for collecting noise and the problem such as the howling occurs can be prevented.

It should be noted that the speaker unit 200 is favorably configured to provide, as the difference between the cancel signal and the return components, the difference which takes close values in a plurality of different bands (e.g., values of 10 dB or more in any bands).

Next, the confirmation of the effects of the present technology by theoretical analysis will be described. Since the speaker unit 200 in FIG. 12 described above is the sealed speaker with the driver DR built in the housing 201, it can be considered that the measurement results include a complex phenomenon of the baffle influence and the like. Here, effects in a case of using an ideal point sound source will be described.

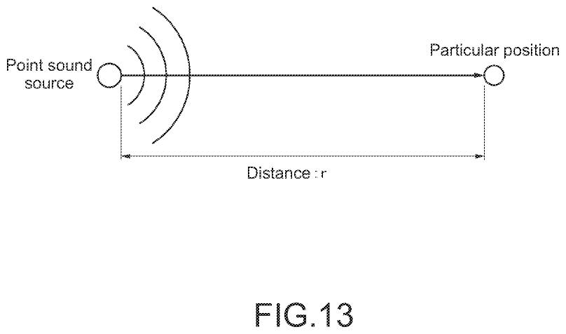

The sound pressure and particle velocity at a particular position of the sound output from the point sound source as shown in FIG. 13 are shown. It should be noted that each variable in the following formulae represents the following value.

r: Distance [m] from the sound source
P(r): Sound pressure by the point sound source at a distance r away from the sound source
V(r): Particle velocity by the point sound source at the distance r away from the sound source
k: Wave number
P+: Strength of the sound source
ρ: Air density
c: Sound velocity

The sound pressure at the particular position of the sound emitted from the point sound source can be expressed by Formula 1 below.

$$Sound pressure : P ( r ) = \frac{1}{r} {P}_{+} {e}^{- j k r} \qquad [ Formula 1 ]$$

Moreover, the particle velocity at the particular position of the sound emitted from the point sound source can be expressed by Formula 2 below.

$$Particle velocity : V ( r ) = \frac{1}{ρ c} \times \frac{1}{r} {P}_{+} {e}^{- j k r} ( 1 + \frac{1}{j k r} ) \qquad [ Formula 2 ]$$

The cardioid characteristics can be obtained by setting the sound pressure and particle velocity to have the same amplitude in “r→∞” as shown in Formula 3 below.

$$( 1 + \frac{1}{j k r} ) \approx 1 … where r \to ∞ \\ \\ \vert P ( r ) \vert = \vert ρ c \times V ( r ) \vert \qquad [ Formula 3 ]$$

That is, the infinity of the uni-directional microphone and the sound collection characteristics can be calculated as shown in Formula 4 below.

$$\begin{matrix}C = P ( r ) + ρ c V ( r ) \\ = \frac{1}{r} {P}_{+} {e}^{- jkr} + \frac{1}{r} {P}_{+} {e}^{- jkr} ( 1 + \frac{1}{jkr} ) \\ \approx \frac{2}{r} {P}_{+} {e}^{- j k r}\end{matrix} \qquad [ Formula 4 ]$$

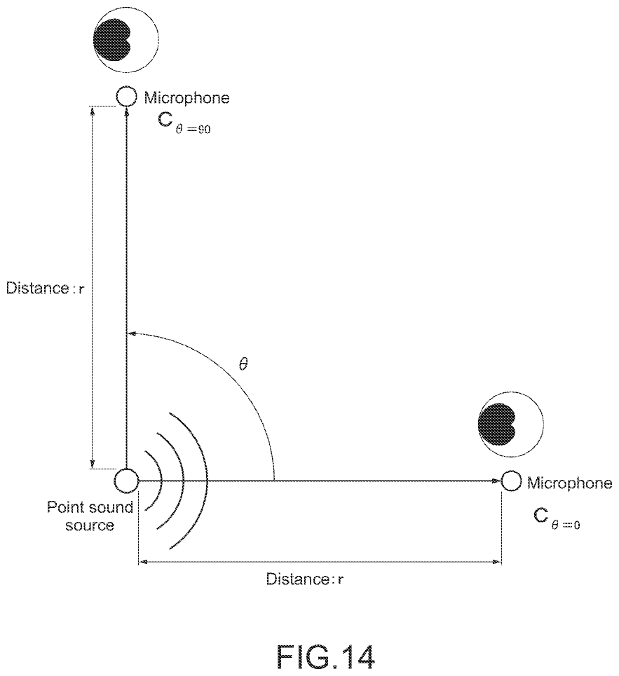

Next, with respect to the angle of arrival of the sound from the point sound source to the microphone as shown in FIG. 14, ideal responses in the uni-directional microphones provided at the position of the angle of arrival θ=0 degrees and the position of the angle of arrival θ=90 degrees in consideration of directivity information of the bi-directivity will be considered. It is assumed that the sound pressure is the same as Formula 2 described above and the particle velocity is the same as Formula 3 described above. C (θ=0), which is an ideal response at the angle of arrival θ=0 degrees, can be expressed by Formula 5 below.

C_{θ=0}=P(r)+ρc×V(r)×cos (0) [Formula 5]

Moreover, C (θ=90), which is an ideal response at the angle of arrival θ=90 degrees, can be expressed by Formula 6 below.

C_{θ=90}=P(r)+ρc×V(r)×cos (90) [Formula 6]

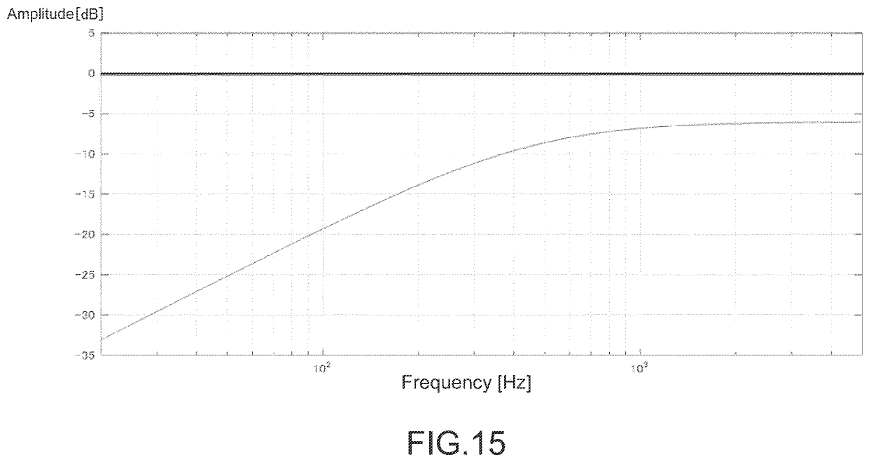

FIG. 15 is a graph showing a sound collection amplitude ratio of the uni-directional microphone provided at the position θ=90 degrees, where the output direction of the cancel signal is set at θ=0 degrees. It is equivalent to the idealization of the positional relationship between the reference microphone and the error microphone shown in FIG. 12 and it is possible to calculate a theoretical error value between the cancel signal and the return components of the cancel signal. The sound collection amplitude ratio can be calculated in accordance with [Formula 7] below. Note that it is assumed that the distance r between the point sound source to the microphone provided at the position θ=0 degrees and the distance r between the point sound source to the microphone provided at the position θ=90 degrees are both 0.06 m.

$$\frac{{C}_{θ = 90}}{{C}_{θ = 0}} = \frac{1}{( 2 + \frac{1}{jkr} )} \qquad [ Formula 7 ]$$

As shown in FIG. 15, it can be seen that the amplitude ratio increases as the frequency lowers. The point sound source is set as the target in the theoretical analysis as described above while the sound source associated with the sealed speaker was set as the target in an examination based on actually measured values. In general, regarding the directivity of the sound source, it increases in linearity and is not the point sound source as the frequency increases to the high range. In the theoretical value analysis, the amplitude ratio is asymptotic to −6 dB the frequency increases to the high range. It can be inferred that it is caused by setting the sound source to be the ideal point sound source. An excellent separation effect of the cancel signal output to the processing area and the return components of the cancel signal that arrive at the microphone MC can be expected from the theoretical calculation value in an assumed actual use environment.

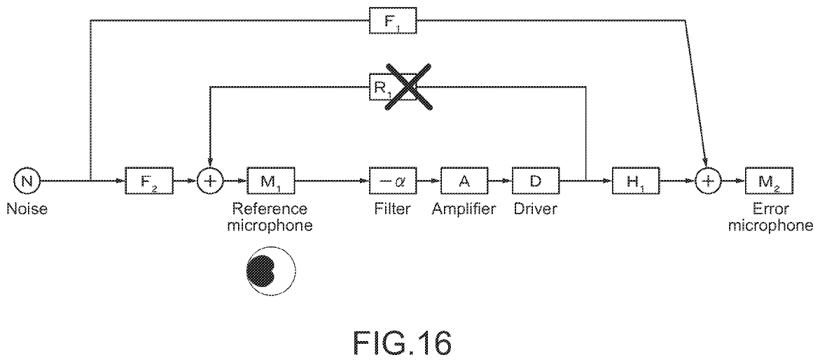

FIG. 16 is a diagram showing the outline of signal processing in a case where the present technology is applied in feedforward noise canceling. R1 (transfer function from the driver DR to the reference microphone) is negligible because the cancel signal (return components) input into the reference microphone M1 from the driver D is sufficiently small as shown in FIG. 16. Therefore, it is possible to prevent a situation where an undesired closed loop is formed between the driver DR and the reference microphone M1 and howling or the like occurs.

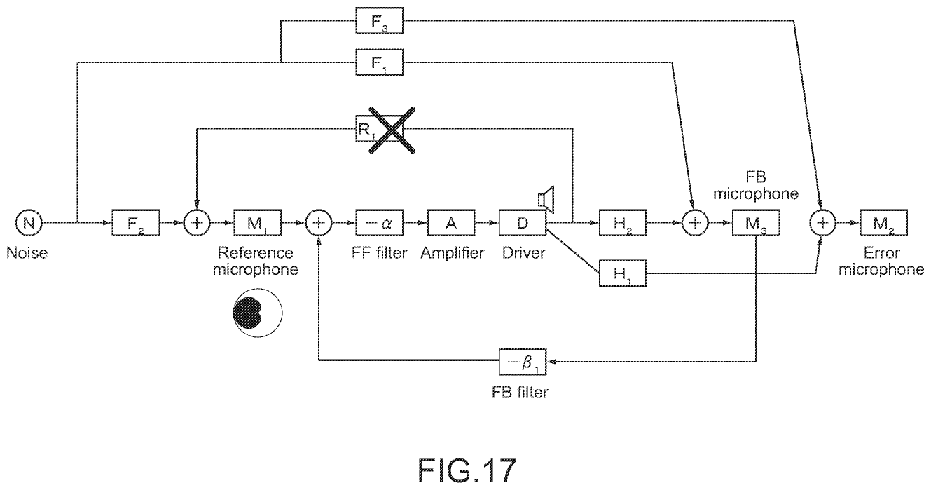

FIG. 17 is a diagram showing the outline of signal processing in a case where a directional microphone is used and the present technology is applied to dual noise canceling combining the feedback system and the feedforward system. The present technology can also be used for the dual noise canceling combining the feedforward and the feedback. The feedback processing in FIG. 17 is a method for directly feeding back errors. It should be noted that the blocks of the transfer function newly generated in FIG. 17 are as follows.

F3: Transfer function from noise to the FB microphone
M3: Feedback microphone (FB microphone)
β: Feedback noise canceling filter
H2: Transfer function from the driver DR to the FB microphone

Also in this case, R1 (transfer function from the driver DR to the reference microphone M1) is negligible because the cancel signal (return components) input into the reference microphone M1 from the driver DR is sufficiently small. Therefore, it is possible to prevent a situation where an undesired closed loop is formed between the driver DR and the reference microphone M1 and howling or the like occurs.

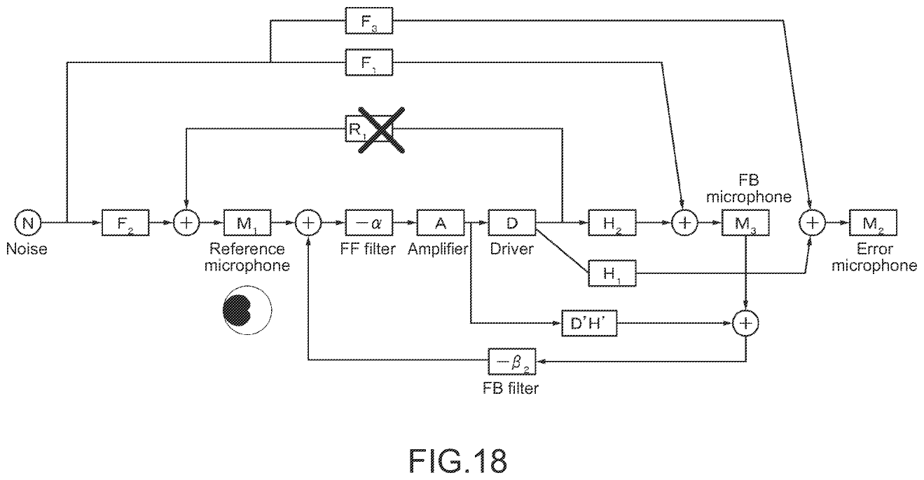

FIG. 18 shows the outline of signal processing in a case where a directional microphone is used and the present technology is applied to dual noise canceling combining the feedback system and the feedforward system (internal model control (IMC)). Although the present technology is applied to the processing of directly feeding back errors in the example shown in FIG. 17, the present technology can also be applied to a method of performing feedback processing after disturbances are restored using an internal model.

Also in this case, R1 (transfer function from the driver DR to the reference microphone M1) is negligible because the cancel signal (return components) input into the reference microphone M1 from the driver DR is sufficiently small. Therefore, it is possible to prevent a situation where an undesired closed loop is formed between the driver DR and the reference microphone M1 and howling or the like occurs.

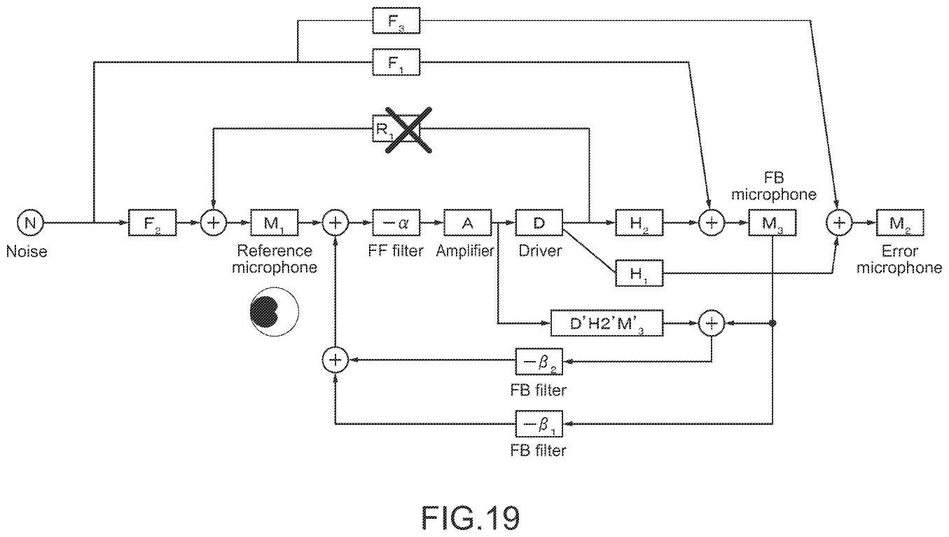

FIG. 19 is a diagram showing the outline of signal processing in a case where a directional microphone is used and the present technology is applied to dual noise canceling combining the feedback system and the feedforward system (double). Also in this case, R1 (transfer function from the driver DR to the reference microphone M1) is negligible because the cancel signal (return components) input into the reference microphone M1 from the driver DR is sufficiently small. Therefore, it is possible to prevent a situation where an undesired closed loop is formed between the driver DR and the reference microphone M1 and howling or the like occurs.

In this way, the present technology is effective not only in the feedforward system but also in the noise canceling using the feedforward system and the feedback system at the same time.

Thus, in accordance with the present technology, in the feedforward noise canceling, the return components of the cancel signal output from the driver arrive at the reference microphone for noise collection, and the return path of the feedback from the driver to the reference microphone can be reduced. This makes it possible to prevent the occurrence of howling due to undesired formation of a closed loop.

The present technology can be used in any environment as long as the present technology is used for the purpose of reducing noise in a space. For example, applying the present technology to a room of a house can reduce noise coming into the room from the outside of the house and noise generated inside the room. Moreover, noise can be reduced even in a large room as appropriate by increasing or decreasing the number of speaker units 200 in accordance with the room size to thereby adjust the scale of the sound system 10. It is also possible to apply the present technology to a vehicle for reducing noise from the outside of the vehicle and reducing noise generated inside the vehicle.

### 2. Modified Examples

Although the embodiment of the present technology has been described above in detail, the present technology is not limited to the above-mentioned embodiment, and various modifications based on the technical idea of the present technology can be made.

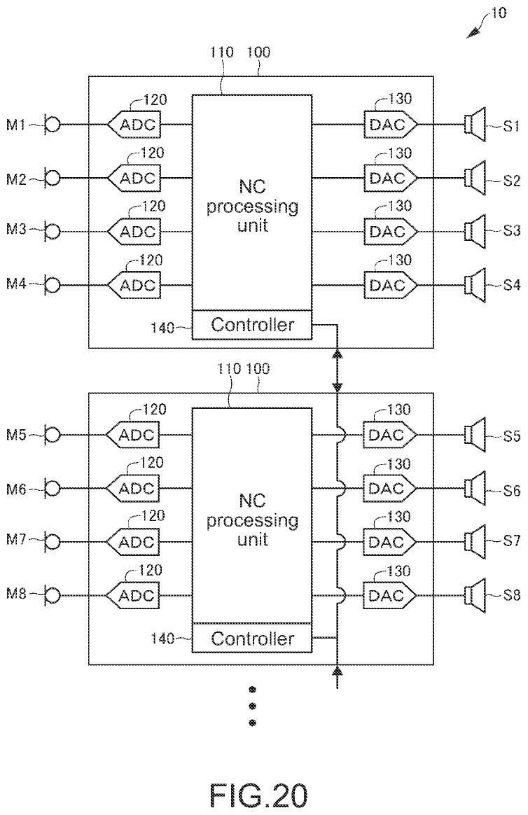

Although the description has been made on the assumption that the single noise canceling processing unit 110 is employed, a plurality of noise canceling processing units may perform processing as shown in FIG. 20. In this case, a controller 140 for sharing latency information and the like between the plurality of noise canceling processing units is required. In a case where the plurality of noise canceling processing units is provided, it is possible to reduce the load on the single noise canceling processing unit and to secure resources and increase the processing speed.

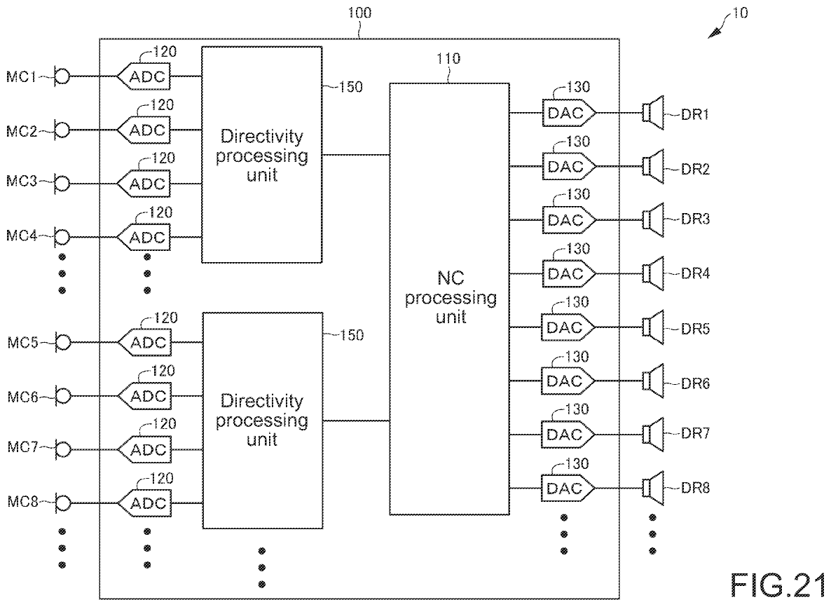

Although the description has been made on the assumption that the directivity of the single microphone is used in the embodiment, the directivity may be formed by combining a plurality of microphones (e.g., a microphone array) as shown in FIG. 21. A directivity processing unit 150 combines digital audio signals supplied from the plurality of microphones MC via the AD converters 120 to form a particular directivity of one microphone in a pseudo manner. The plurality of microphones in this case may be omni-directional microphones or may include an omni-directional microphone. Arranging and using a plurality of omni-directional microphones as the microphone array and further performing processing by the directivity processing unit 150 can give directivity (use of a so-called beamforming technique).

An audio content signal may be supplied from the sound source to the noise canceling processing unit 110 via a digital I/F. The sound source includes various media players such as music players, DVD players, Blu-ray (registered trademark) players, and car stereos. The audio content signal supplied from the sound source is an audio signal reproduced by the media player. The user listens to such an audio content signal as audio content within the processing area of the noise canceling by the signal processing apparatus 100100.

In a case where the user listens to the audio content from the sound source in the processing area of the signal processing apparatus 100, the audio content reproduced from the sound source within the processing area and noise are input into the microphone MC. Using the audio content signal supplied via the digital I/F in the noise canceling processing unit 110, the audio content is removed from the signal of the audio content and the noise to thereby generate a signal of the noise only. A cancel signal is generated from the signal of the noise only and output from the speaker unit 200. In this manner, only the noise can be reduced without affecting the audio content reproduced from the sound source within the processing area.

The present technology can also take the following configurations.
(1) A speaker unit that constitutes a sound system that reduces noise in an open space, including:

a housing;

a driver; and

a microphone, in which

the microphone and the driver are provided in the housing such that sensitivity of the microphone to a signal output from the driver is lower.
(2) The speaker unit according to (1), in which

the microphone is a directional microphone.
(3) The speaker unit according to (2), in which
the directional microphone is a bi-directional microphone.
(4) The speaker unit according to (1), in which

the microphone is an omni-directional microphone.
(5) The speaker unit according to (2), in which

the directional microphone is configured by combining a bi-directional microphone with an omni-directional microphone.
(6) The speaker unit according to any of (2) to (4), in which

the directional microphone is a uni-directional microphone.
(7) The speaker unit according to any of (1) to (5), in which
the microphone is disposed in the housing such that a direction in which the sensitivity of the microphone is lower corresponds to the driver.
(8) The speaker unit according to any of (1) to (6), in which

the microphone is provided in the housing such that a directivity direction corresponds to a direction of a noise source.
(9) The speaker unit according to any of (1) to (7), in which

the signal is a cancel signal for noise reduction generated by a noise canceling processing unit.
(10) The speaker unit according to (9), in which

a sound pressure difference between the cancel signal output from the driver and the cancel signal that arrives at the microphone is 10 dB or more at a predetermined frequency.
(11) The speaker unit according to any of (1) to (9), in which

the microphone is provided at a position at which noise from a noise source is not shielded and which is a position closest to the driver.
(12) A sound system 10 that includes a plurality of speaker units and reduces noise in an open space, the speaker units each including

a housing,

a speaker, and

a microphone, in which

the microphone and the driver are provided in the housing such that sensitivity of the microphone to a signal output from the driver is lower.
(13) The sound system according to (12), further including

a noise cancel processing unit that generates a cancel signal.
(14) The sound system according to (13), in which the noise cancel processing unit generates a feedforward noise cancel signal.
(15) The sound system according to (13), in which

the noise cancel processing unit generates a feedback noise cancel signal.

### REFERENCE SIGNS LIST

10 sound system
110 noise canceling processing unit
200 speaker unit
201 housing
DR driver
MC microphone

1. A speaker unit that constitutes a sound system that reduces noise in an open space, comprising:
a housing;
a driver; and
a microphone, wherein
the microphone and the driver are provided in the housing such that sensitivity of the microphone to a signal output from the driver is lower.

2. The speaker unit according to claim 1, wherein
the microphone is a directional microphone.

3. The speaker unit according to claim 2, wherein
the directional microphone is a bi-directional microphone.

4. The speaker unit according to claim 1, wherein
the microphone is an omni-directional microphone.

5. The speaker unit according to claim 2, wherein
the directional microphone is configured by combining a bi-directional microphone with an omni-directional microphone.

6. The speaker unit according to claim 2, wherein
the directional microphone is a uni-directional microphone.

7. The speaker unit according to claim 1, wherein
the microphone is disposed in the housing such that a direction in which the sensitivity of the microphone is lower corresponds to the driver.

8. The speaker unit according to claim 1, wherein
the microphone is provided in the housing such that a directivity direction corresponds to a direction of a noise source.

9. The speaker unit according to claim 1, wherein
the signal is a cancel signal for noise reduction generated by a noise canceling processing unit.

10. The speaker unit according to claim 9, wherein
a sound pressure difference between the cancel signal output from the driver and the cancel signal that arrives at the microphone is 10 dB or more at a predetermined frequency.

11. The speaker unit according to claim 1, wherein
the microphone is provided at a position at which noise from a noise source is not shielded and which is a position closest to the driver.

12. A sound system 10 that includes a plurality of speaker units and reduces noise in an open space, the speaker units each including
a housing,
a speaker, and
a microphone, wherein
the microphone and the driver are provided in the housing such that sensitivity of the microphone to a signal output from the driver is lower.

13. The sound system according to claim 12, further comprising
a noise cancel processing unit that generates a cancel signal.

14. The sound system according to claim 13, wherein
the noise cancel processing unit generates a feedforward noise cancel signal.

15. The sound system according to claim 13, wherein
the noise cancel processing unit generates a feedback noise cancel signal.
